(19) United States
(12) Patent Application Publication
(10) Pub. No.: US 2020/0063028 A1
(43) Pub. Date: Feb. 27, 2020

(54) CAPSULES, SYSTEMS AND METHODS FOR TARGETED DELIVERY OF CHEMICALS INTO MULTIPHASE ENVIRONMENTS

(71) Applicant: ExxonMobil Research and Engineering Company, Annandale, NJ (US)

(72) Inventors: Fang Cao, Basking Ridge, NJ (US); Mohsen S. Yeganeh, Newtown, PA (US); Yao Xiong, Cypress, TX (US); David S. Fischer, Houston, TX (US); Aruna Mohan, Annandale, NJ (US); Wei Li, Spring, TX (US)

(21) Appl. No.: 16/542,772

(22) Filed: Aug. 16, 2019

Related U.S. Application Data
(60) Provisional application No. 62/720,473, filed on Aug. 21, 2018.

(51) Int. Cl. C09K 8/92; C09K 8/54; C09K 8/60; E21B 41/02

(52) U.S. Cl. CPC C09K 8/92; C09K 8/54; C09K 2208/32; E21B 41/02; C09K 8/605

(57) ABSTRACT

Capsules, systems and methods for delivering chemical components to multiphase environments are disclosed. The systems and methods utilize delivery capsules within which the chemical components are encapsulated. The chemical components may be corrosion inhibitors or biocides and the multiphase environment an oil/water environment, for example, within an oil transport pipeline. The systems and methods allow delivery of the capsules to targeted areas of the multiphase environment, for example, to a water phase or a water/metal interface.

### CROSS REFERNCE TO RELATED APPLICATIONS

This application claims priority to U.S. Provisional Application Ser. No. 62/720,473 filed Aug. 21, 2018, which is herein incorporated by reference in its entirety.

### FIELD

This disclosure relates to capsules, systems and methods for delivering chemicals to targeted areas in multiphase environments. In particular, the chemicals are corrosion inhibitors and/or biocides and the multiphase environments are oil/gas/water environments. The chemicals are contained in degradable capsules, specifically designed to target, for example, a water phase or a water/metal interface of, for example, an oil or gas pipeline.

### BACKGROUND

Corrosion is a common but serious problem encountered in the petroleum industry and its occurrence has important implications for both capital and operational expenditures in relation to equipment integrity and for health, safety and the environment. The most important opportunity for cost saving and safe operation is to control corrosion and minimize or prevent corrosion failures. Corrosion inhibitor injection and biocide treatment are cost-effective and commonly practiced methods to control abiotic corrosion and microbially induced corrosion, respectively, of carbon steel pipelines used in the oil and gas industry.

In the case of corrosion inhibitor injection for abiotic corrosion control, the active components in commercial corrosion inhibitor packages are usually organic surfactants, for example, nitrogen based surfactants such as amines, imidazoline and derivatives. Due to the amphiphilic nature of surfactants, a significant fraction of the injected corrosion inhibitor will inevitably reside in the oil phase through partitioning and/or at the oil/water interface, thus reducing the effectiveness of the inhibitors due to lowered corrosion inhibitor concentration in the water phase. Therefore, to enhance the effectiveness of a corrosion inhibition program in the field, there is a need to promote corrosion inhibitor partitioning in the water phase and/or deliver corrosion inhibitors directly to the water/steel interface.

For effective biocide treatment of microbially induced corrosion, biocides must be able to sufficiently penetrate the biofilm and contact the sessile bacteria. As a result, batch and semi-continuous (or slug) methods are normally used for biocide injection. Poor mixing of the biocide due to channelling, chemical degradation of the biocide, or inadequate contact time often results in an ineffective biocide treatment. Targeted delivery of the biocide to the biofilm at the water/steel interface would significantly enhance the effectiveness of biocide treatment by providing high concentration gradients which facilitate penetration of the biocide throughout the biomass. In addition, it may reduce the amount of water soluble biocide required for batch and semi-continuous methods because of the reduction of biocide loss into the bulk water phase.

Accordingly, in view of the foregoing, it would be desirable to provide alternative systems and methods for delivering chemicals, such as corrosion inhibitors and biocides, into multiphase environments.

The reference in this specification to any prior publication (or information derived from it), or to any matter which is known, is not, and should not be taken as an acknowledgement or admission or any form of suggestion that the prior publication (or information derived from it) or to known matter forms part of the common general knowledge in the field of endeavour to which this specification relates.

### SUMMARY

The present disclosure is related to novel capsules, systems and methods which deliver chemical components, for example corrosion inhibitors and/or biocides, to multiphase environments, for example water/gas or water/oil or water/gas/oil environments. The capsules, systems and methods may deliver the chemical components to targeted areas, such as the water phase or the water/metal interface, for example to the wall of an oil or gas pipeline.

The present disclosure is particularly related to encapsulating chemicals in delivery capsules, the shell of said capsules being, in some embodiments, rapidly degraded or dissolved in an aqueous environment to quickly release their contents, or, in other embodiments, more slowly degraded or dissolved to release their contents in a time controlled manner. The density of the delivery capsules (comprising the capsule shell and contents) may be controlled by utilizing liquid and/or water-soluble solids encapsulated in the delivery capsule so the delivery capsule can enter one phase (e.g. oil) in, for example, a pipeline and reach a different phase (e.g. water) to deliver the encapsulated chemicals to the targeted area (e.g. water/steel interface). The material of the shell of the capsule may be designed to be compatible with oil and the chemicals of interest, but to dissolve in water over time. The time for the shell of the delivery capsule to dissolve in water may be dependent on the environmental condition (e.g., pH, temperature) and may be engineered to achieve time controlled release of chemicals, depending on the need of the application. Controlled delivery of chemicals to the water phase or water/steel interface inside a pipe may significantly reduce the overall amount of chemicals required due to the reduced chemical loss in the oil phase or oil/water interface. In addition, the disclosed capsules, systems and methods may substantially promote the efficiency and performance of the chemicals of interest because of the enhanced chemical concentration at the targeted delivery area.

In one aspect the present disclosure provides a delivery capsule, said delivery capsule comprising one or more chemical components encapsulated within a shell, said shell being degradable and/or soluble in an aqueous environment.

In another aspect the present disclosure provides a chemical component delivery system, said system comprising a plurality of delivery capsules, said delivery capsules comprising one or more chemical components encapsulated within shells, said shells being degradable and/or soluble in an aqueous environment.

In another aspect the present disclosure provides a method of delivering chemical components to a water phase of a multiphase environment comprising the steps of: introducing one or more delivery capsules to a multiphase environment, said capsules comprising one or more chemical components encapsulated within shells, said shells being degradable and/or soluble in an aqueous environment;

allowing the capsules to migrate to the water phase; and
allowing the components to be released from the delivery capsules.

In another aspect the present disclosure provides a method of delivering chemical components to a water/vessel wall interface of a multiphase environment comprising the steps of: introducing one or more delivery capsules to a multiphase environment, said capsules comprising one or more chemical components encapsulated within shells, said shells being degradable and/or soluble in an aqueous environment;

allowing the capsules to migrate to the water/vessel wall interface; and
allowing the components to be released from the delivery capsules.

In any one of the herein disclosed aspects the chemical components may comprise one or more corrosion inhibitors, one or more biocides, or mixtures thereof.

In some embodiments the system comprises a plurality of delivery capsules, said delivery capsules comprising one or more corrosion inhibitors encapsulated therein. In other embodiments the system comprises a plurality of delivery capsules, said delivery capsules comprising one or more biocides encapsulated therein.

In another aspect the present disclosure provides a chemical component delivery system, said system comprising at least a first fraction of delivery capsules comprising one or more of a first set of chemical components encapsulated therein, and at least a second fraction of delivery capsules comprising one or more of a second set of chemical components encapsulated therein, wherein the second set of chemical components comprise at least some chemicals which are different to those of the first set.

In some embodiments the system may comprise at least a first fraction of delivery capsules comprising one or more corrosion inhibitors encapsulated therein and at least a second fraction of delivery capsules comprising one or more corrosion inhibitors encapsulated therein, wherein at least some of the corrosion inhibitors encapsulated in the first and second fractions are different.

In some embodiments the system may comprise at least a first fraction of delivery capsules comprising one or more biocides encapsulated therein and at least a second fraction of delivery capsules comprising one or more biocides encapsulated therein, wherein at least some of the biocides encapsulated in the first and second fractions are different.

In some embodiments the system may comprise at least a first fraction of delivery capsules comprising one or more corrosion inhibitors encapsulated therein and at least a second fraction of delivery capsules comprising one or more biocides encapsulated therein.

In some embodiments the system may comprise at least a third fraction of delivery capsules comprising other chemical components encapsulated therein.

In some embodiments individual delivery capsules may contain one or more corrosion inhibitors mixed with one or more biocides. In other embodiments individual delivery capsules may comprise two or more separate compartments each comprising different chemical components. For example, one compartment may comprise one or more corrosion inhibitors and the other compartment one or more biocides.

Such arrangements may be advantageous if certain chemical components are non-compatible. In this way, flexible storage and eventual delivery of active chemical components may be achieved.

In some embodiments the capsules may comprise one or more further capsules encapsulated therein. Said encapsulated capsules may comprise the same or different chemical components to those encapsulated in the main capsule.

In any one or more of the herein disclosed aspects the materials of construction of the capsule shell may be engineered so as to control the release of the encapsulated chemicals. For example, the shell material may be engineered to rapidly degrade and/or dissolve in water and/or acidic water, or brine and/or acidic brine so as to quickly release the encapsulated chemical components. In other examples, the capsule shell material may be engineered to more slowly degrade and/or dissolve in water and/or acidic water or brine and/or acidic brine so as to release the encapsulated chemical components over an extended period of time.

In any one or more of the herein disclosed aspects the delivery capsule shell may comprise materials that degrade or dissolve in aqueous environments, such as aqueous acidic, brine or acidic brine environments. Preferably, the material of the shell is resistant to degradation or dissolution in an oil environment.

The delivery capsule shell may comprise dextran, cellulose, chitin, chitosan, protein, aliphatic polyester, poly(lactide), poly(glycolide), poly(ε-caprolactone), poly(hydroxy butyrate), poly(anhydride), aliphatic poly(carbonate), poly(orthoester), poly(amino acid), poly (ethylene oxide), poly(phosphazene) or polyurethanes comprising ester linkages.

The delivery capsule shell may comprise gelatin, hydroxy propyl methyl cellulose, pectin, polyethylene oxide, polyvinyl alcohol, alginate, polycaprolactone, or a gelatinized starch-based material.

In some preferred embodiments the delivery capsule shell comprises gelatin or hydroxypropyl methyl cellulose.

In some embodiments the systems disclosed herein may comprise a first fraction of delivery capsules comprising capsule shells engineered to quickly degrade and/or dissolve and a second fraction of delivery capsules comprising capsule shells engineered to more slowly degrade and/or dissolve. The first and second fractions may comprise capsules comprising the same or different chemical components.

For example, a first fraction of delivery capsules may comprise a corrosion inhibitor and comprise a shell material designed to degrade quickly, whereas a second fraction of delivery capsules may comprise a biocide and comprise a shell designed to degrade more slowly. Accordingly, time controlled delivery of particular chemical components is achieved.

In some embodiments the chemical components comprise a liquid, a solid, or a mixture thereof. In some embodiments the chemical components comprise a powder.

In some embodiments the density of the delivery capsule (that is the density of the capsule shell and encapsulated materials) may be greater than the density of water. In other embodiments the density of the delivery capsule may be greater than the density of brine.

Accordingly, the delivery capsule may migrate preferentially to the higher density aqueous phase of an oil/water multiphase environment.

Typically light crude oil has a density less than 0.87 g/cm³, medium crude oil a density from 0.87 to 0.92 g/cm³, heavy crude oil a density from 0.92 to 1.00 g/cm³ and extra-heavy crude oil a density greater than 1.00 g/cm³

In some embodiments the density of the delivery capsule may be greater than 1.00 g/cm³, or greater than 1.05 g/cm³, or greater than 1.10 g/cm³, or greater than 1.15 g/cm³, or greater than 1.20 g/cm³.

In some embodiments the density of the delivery capsule may be between about 1.00 g/cm³ and about 3.00 g/cm³ or between about 1.05 g/cm³ and about 2.00 g/cm³, or between about 1.15 g/cm³ and about 2.00 g/cm³.

In some embodiments the delivery capsule comprises one or more liquid components having a higher density than water or brine.

In some embodiments the density of the one or more liquid components may be greater than 1.00 g/cm³, or greater than 1.05 g/cm³, or greater than 1.10 g/cm³, or greater than 1.15 g/cm³, or greater than 1.20 g/cm³.

In some embodiments the delivery capsule comprises one or more liquid components which are miscible with water. This is advantageous as after the delivery capsule is ruptured and its contents delivered to an aqueous phase the liquid component is soluble in the aqueous phase.

In some embodiments the delivery capsule comprises one or more liquids components having both a higher density than water and miscibility with water.

Examples of suitable liquids include polyols such as ethylene glycol, diethylene glycol and glycerol.

In some embodiments the delivery capsules comprises one or more solid components having a higher density than water or brine.

In some embodiments the density of the one or more solid components may be greater than 1.00 g/cm³, or greater than 1.05 g/cm³, or greater than 1.10 g/cm³, or greater than 1.15 g/cm³, or greater than 1.20 g/cm³, or greater than 1.50 g/cm³, or greater than 2.0 g/cm³.

The density of the one or more solid components may be between about 1.00 g/cm³ and about 3.0 g/cm³.

In some embodiments the capsule comprises one or more solid components which are miscible with water.

In some embodiments the capsule comprises one or more solid components having both a higher density than water and miscibility with water.

Examples of suitable solid components include alkali metal salts, alkaline earth salts and ammonium salts. Non-limiting examples of salts include sodium chloride, sodium bromide, sodium iodide, magnesium chloride, calcium chloride, sodium sulphate, potassium nitrate, and ammonium chloride.

Accordingly, by varying the amount and nature of the solid and/or liquid components in the delivery capsule, the density of the delivery capsule may be adjusted.

In some embodiments the multiphase environment is an oil and water environment.

In some embodiments the water is production water from an oil well.

In some embodiments the oil is crude oil from an oil well.

The size of the delivery capsule may be varied depending on the environment wherein delivery is required. The size may be in the nanometre range, or alternatively, in the micron range.

In some embodiments the delivery capsule is about 10 nm to about 20 mm in size, or about 5 micron to about 10 mm, or about 10 micron to about 5 mm, or about 10 micron to about 1 mm, or about 10 micron to about 500 micron, or about 10 micron to about 200 micron, or about 10 micron to about 100 micron.

In some embodiments the delivery capsule is about 10 nm to about 1000 nm in size. In other embodiments the delivery capsule is about 1 micron to about 20 mm in size. In yet other embodiments the delivery capsule is about 100 microns to about 10 mm in size.

In some embodiments the capsule may have a wall thickness of about 1 nm to about 2 mm, or from about 0.5 micron to about 1 mm, or from about 20 micron to about 0.5 mm, or from about 50 micron to about 300 micron. It will be appreciated that the wall thickness is generally related to capsule size, that is, larger capsules will usually have thicker walls.

In some embodiments the wall thickness is about 1 nm to about 100 nm. In other embodiments the wall thickness is about 100 nm to about 100 micron.

Along with the material of delivery capsule shell construction the wall thickness may regulate the time within in which the shell degrades and/or dissolves so as to release the encapsulated chemicals. In this way, control of chemical component release is possible.

In some embodiments the shell of the delivery capsule comprises a degradable material that degrades so as to substantially dissolve in water over time.

In some embodiments the rate of degradation of the shell of the delivery capsule increases with decreasing pH.

In some embodiments the water may have a pH less than 7.0, or less than 6.0, or less than 5.0, or less than 4.0.

In some embodiments the capsule shell may rupture so as to release at least some of the encapsulated chemical components within 30 minutes or less of being exposed to water, or 20 minutes or less, or 10 minutes or less, or 5 minutes or less. The water may be acidic water, or brine, or acidic brine.

In some embodiments the capsule shell may substantially dissolve in water. This is particularly advantageous as substantially no residual shell shards may remain which otherwise may contribute to fouling or even blockages in transport systems, such as pipelines.

In some embodiments the capsule shell may substantially dissolve in acidic water, or brine, or acidic brine.

In some embodiments the capsule migrates to a water/metal interface of a vessel within which the multiphase environment resides.

The corrosion inhibitor may be selected from commercially available corrosion inhibitor packages used in the art of corrosion protection in oil and/or gas transport and/or storage.

The corrosion inhibitor may comprise one or more surfactants selected from a non-ionic surfactant, an ionic surfactant, an amphoteric surfactant, or mixtures thereof.

The biocide may be selected from one or more biocides used in the art to protect and/or control abiotic corrosion and microbially induced corrosion in oil and/or gas transport and/or storage.

In a further aspect the present disclosure provides a use of the capsules or systems according to any one or more of the herein disclosed embodiments in preventing, and/or controlling, and/or removing, corrosion in oil and/or gas transport and/or storage.

In a further aspect the present disclosure provides a method for preventing, and/or controlling, and/or removing, corrosion in oil and/or gas transport and/or storage comprising the steps of:

introducing one or more delivery capsules according to any one or more of the herein disclosed embodiments to a multiphase environment, said capsules comprising one or more chemical components encapsulated within shells, said shells being degradable and/or soluble in an aqueous environment;
allowing the capsules to migrate to a water phase; and
allowing the components to be released from the delivery capsules.

In a further aspect the present disclosure provides a method for preventing, and/or controlling, and/or removing, corrosion in oil and/or gas transport and/or storage comprising the steps of:

introducing one or more delivery capsules according to any one or more of the herein disclosed embodiments to a multiphase environment, said capsules comprising one or more chemical components encapsulated within shells, said shells being degradable and/or soluble in an aqueous environment;
allowing the capsules to migrate to a water/vessel wall interface; and
allowing the components to be released from the delivery capsules.

In a further aspect the present disclosure provides a method for preventing, and/or controlling, and/or removing, corrosion in oil and/or gas transport and/or storage comprising the steps of:

introducing one or more chemical component delivery systems, according to any one or more of the herein disclosed embodiments, to an oil/water and/or gas/water multiphase environment, said system comprising a plurality of delivery capsules, said delivery capsules comprising one or more chemical components encapsulated within shells, said shells being degradable and/or soluble in an aqueous environment;
allowing the capsules to migrate to a water phase; and
allowing the components to be released from the delivery capsules.

In a further aspect the present disclosure provides a method for preventing, and/or controlling, and/or removing, corrosion in oil and/or gas transport and/or storage comprising the steps of:

introducing one or more chemical component delivery systems, according to any one or more of the herein disclosed embodiments, to an oil/water and/or gas/water multiphase environment, said system comprising a plurality of delivery capsules, said delivery capsules comprising one or more chemical components encapsulated within shells, said shells being degradable and/or soluble in an aqueous environment;
allowing the capsules to migrate to a water/vessel wall interface; and
allowing the components to be released from the delivery capsules.

Further features and advantages of the present disclosure will be understood by reference to the following drawings and detailed description.

### BRIEF DESCRIPTION OF THE DRAWINGS

FIG. 1 shows photographs of gelatin capsules containing commercial corrosion inhibitor packages.

FIG. 2 shows photographs of gelatin capsules containing crude oils.

FIG. 3 shows photographs of gelatin capsules suspended in acidic brine.

FIG. 4 shows photographs of gelatin capsules suspended in acidic brine at 50° C.

FIG. 5 shows a photograph of a hydroxypropylmethyl cellulose capsule containing sodium chloride suspended in ethylene glycol.

FIG. 6 is a chart showing corrosion rate plotted against time for encapsulated corrosion inhibitor and non-encapsulated inhibitor.

### DETAILED DESCRIPTION OF THE EMBODIMENTS

Before the present processes are disclosed and described, it is to be understood that unless otherwise indicated this disclosure is not limited to specific compositions, components, methods, or the like, as such may vary, unless otherwise specified. It is also to be understood that the terminology used herein is for the purpose of describing particular embodiments only and is not intended to be limiting.

It must also be noted that, as used in the specification and the appended claims, the singular forms ‘a’, ‘an’ and ‘the’ include plural referents unless otherwise specified. Thus, for example, reference to ‘corrosion inhibitor’ may include more than one corrosion inhibitors, and the like.

Throughout this specification, use of the terms ‘comprises’ or ‘comprising’ or grammatical variations thereon shall be taken to specify the presence of stated features, integers, steps or components but does not preclude the presence or addition of one or more other features, integers, steps, components or groups thereof not specifically mentioned.

All numerical values as used herein are modified by ‘about’ or ‘approximately’ the indicated value, and take into account experimental error and variations that would be expected by a person having ordinary skill in the art.

In the following, definitions are included to provide a clear and consistent understanding of the specification and claims. As used herein, the recited terms have the following meanings. All other terms and phrases used in this specification have their ordinary meanings as one of skill in the art would understand.

Capsule Shell

The delivery capsules of the present disclosure are preferably made from a degradable material that degrades when subjected to an aqueous acidic environment so as to release the chemical components that are contained in the delivery capsules into the aqueous phase. Such degradable materials may include degradable polymers. One of ordinary skill in the art will be able to determine the appropriate degradable material to achieve the desired degradation properties in a particular environment.

Suitable examples of degradable materials include, but are not limited to, polysaccharides such as dextrans or celluloses, chitins, chitosans, proteins (for example gelatin), aliphatic polyesters, poly(glycolides), poly(lactides), poly(ε-caprolactones), poly(hydroxybutyrates), poly(anhydrides), aliphatic poly(carbonates), poly(orthoesters), poly(amino acids), poly(ethylene oxides), poly(phosphazenes) and degradable polyurethanes.

Examples include hydroxy propyl methylcellulose, pectin, polyethylene oxide, polyvinyl alcohol, alginate, polycaprolactone, gelatinised starch-based materials, and the like. In preferred embodiments, gelatin or hydroxy propyl methylcellulose may be used as the degradable shell materials.

In some embodiments, the delivery capsules may be coated with coatings which may impart a degree of resistance, if desired, to the delivery capsule's solubility. This may be desirable when a delay period is beneficial before the chemical components contained within the delivery capsules are released

Different degradable materials and different thicknesses of degradable materials may be used to define the different chambers in a delivery capsule or different delivery capsules within a system. For instance, using a thicker material to define one chamber in a capsule may result in a slightly delayed release of the chemical component within that chamber. In this way, it is possible to provide for the release of different chemical components in the chambers under different conditions, for instance, different temperatures or at different pHs. In one embodiment, such different degradable materials in a capsule may be used to facilitate the delivery of a first chemical component to one area of a pipeline and the delivery of a second chemical component to a second area of a pipeline.

Similarly, it is possible to provide for the release of different chemical components in different capsules of a system under different conditions, for instance, different temperatures or at different pHs. In one embodiment, such different degradable materials in a system comprising a plurality of capsules may be used to facilitate the delivery of a first chemical component to one area of a pipeline and the delivery of a second chemical component to a second area of a pipeline.

Corrosion Inhibitor

The corrosion inhibitor may be selected from commercially available corrosion inhibitor packages used in the art of corrosion protection in oil and/or gas transport and/or storage.

The corrosion inhibitor may comprise one or more surfactants selected from a non-ionic surfactant, an ionic surfactant, an amphoteric surfactant, or mixtures thereof.

As used herein, a “nonionic surfactant” refers to a surfactant in which the molecules forming the surfactant are uncharged. Suitable nonionic surfactant include, but are not limited to, condensation products of ethylene oxide with phenols, naphthols, and alkyl phenols, for example octyphenoxy-nonaoxyethyleneethanol. Examples of nonionic surfactants include, but are not limited to, ethylene glycol monostearate, propylene glycol myristate, glyceryl monostearate, glyceryl stearate, polyglyceryl-4-oleate, sorbitan acylate, sucrose acylate, PEG-150 laurate, PEG-400 monolaurate, polyoxyethylene monolaurate, polysorbates, ii polyoxyethylene octylphenylether, PEG-1000 cetyl ether, polyoxyethylene tridecyl ether, polypropylene glycol butyl ether, stearoyl monoisopropanolamide, and polyoxyethylene hydrogenated tallow amide. Other examples of nonionic surfactants include, but are not limited to, fatty acid glycerine esters, sorbitan fatty acid esters, sucrose fatty acid esters, polyglycerine fatty acid esters, higher alcohol ethylene oxide adducts, single long chain polyoxyethylene alkyl ethers, polyoxyethylene alkyl allyl ethers, polyoxyethylene lanolin alcohol, polyoxyethylene fatty acid esters, polyoxyethylene glycerine fatty acid esters, polyoxyethylene propylene glycol fatty acid esters, polyoxyethylene sorbitol fatty acid esters, polyoxyethylene castor oil or hardened castor oil derivatives, polyoxyethylene lanolin derivatives, polyoxyethylene fatty acid amides, polyoxyethylene alkyl amines, an alkylpyrrolidone, glucamides, alkylpolyglucosides, mono- and dialkanol amides, a polyoxyethylene alcohol mono- or diamides and alkylamine oxides.

As used herein, an “ionic surfactant” refers to a surfactant in which the molecules forming the surfactant are charged. Suitable ionic surfactants include, but are not limited to, sulfonates, sulfates, ammonium, phosphonium, and sulphonium alkylated quaternary or ternary compounds, singly or attached to polymeric compounds. Suitable anionic surfactants include, but are not limited to, those containing carboxylate, sulfonate, and sulfate ions. Examples of anionic surfactants include, but are not limited to, sodium, potassium, ammonium of long chain alkyl sulfonates and alkyl aryl sulfonates such as sodium dodecylbenzene sulfonate; dialkyl sodium sulfosuccinates, such as sodium dodecylbenzene sulfonate; dialkyl sodium sulfosuccinates, such as sodium bis-(2-ethylthioxyl)-sulfosuccinate; and alkyl sulfates such as sodium lauryl sulfate. Cationic surfactants include, but are not limited to, quaternary ammonium compounds such as benzalkonium chloride, benzethonium chloride, cetrimonium bromide, stearyl dimethylbenzyl ammonium chloride, polyoxyethylene (15), and coconut amine. Examples of the anionic surfactants include, but are not limited to, fatty acid soaps, ether carboxylic acids and salts thereof, alkane sulfonate salts, α-olefin sulfonate salts, sulfonate salts of higher fatty acid esters, higher alcohol sulfate ester salts, fatty alcohol ether sulfates salts, higher alcohol phosphate ester salts, fatty alcohol ether phosphate ester salts, condensates of higher fatty acids and amino acids, and collagen hydrolysate derivatives. Examples of the cationic surfactants include, but are not limited to, alkyltrimethylammonium salts, dialkyldimethylammonium salts, alkyldimethylbenzylammonium salts, alkylpyridinium salts, alkylisoquinolinium salts, benzethonium chloride, and acylamino acid type cationic surfactants.

As used herein, an “amphoteric surfactant” refers to a surfactant compound uniquely structured to function as cationic surfactants at acid pH and anionic surfactants at alkaline pH. Suitable amphoteric surfactants include, but are not limited to, amino acid, betaine, sultaine, phosphobetaines, and imidazoline type amphoteric surfactants. Examples for amphoteric surfactants include, but are not limited to, sodium N-dodecyl-beta-alanine, sodium N-lauryl-beta-iminodipropionate, myristoamphoacetate, lauryl betaine, and laurylsulfobetaine.

Biocides

As used herein, the term “biocide” refers to agents such as germicides, bactericides, disinfectants, sterilizers, preservatives, fungicides, algicides, aquaticides, herbicides and the like, each of which may be used for their ability to inhibit growth of and/or destroy various biological and/or microbiological species such as bacteria, fungi, algae and the like.

Examples of suitable biocides may include both so-called non-oxidizing and oxidizing biocides. Examples of commonly available oxidizing biocides include hypochlorite bleach, such as calcium hypochlorite and lithium hypochlorite, peracetic acid, potassium monopersulfate, potassium peroxymonosulfate, bromochlorodimethylhydantoin, dichloroethylmethylhydantoin, chloroisocyanurate, trichloroisocyanuric acids and dichloroisocyanuric acids and salts thereof, or chlorinated hydantoins. Suitable oxidizing biocides may also include, for example bromine products such as stabilized sodium hypobromite, activated sodium bromide, or brominated hydantoins. Suitable oxidizing biocides may also include, for example chlorine dioxide, ozone, inorganic persulfates such as ammonium persulfate, or peroxides, such as hydrogen peroxide and organic peroxides.

Examples of non-oxidizing biocides include quaternary ammonium salts, aldehydes and quaternary phosphonium salts.

Examples of aldehydes include formaldehyde, glyoxal, furfural, acrolein, methacrolein, propionaldehyde, acetaldehyde, crotonaldehyde and mixtures thereof. Examples of quaternary ammonium salts include pyridinium biocides, benzalkonium chloride, cetrimide, cetyl trimethyl ammonium chloride, benzethonium chloride, cetylpyridinium chloride, chlorphenoctium amsonate, dequalinium acetate, dequalinium chloride, domiphen bromide, laurolinium acetate, methylbenzethonium chloride, myristyl-gamma-picolinium chloride, ortaphonium chloride, triclobisonium chloride, alkyl dimethyl benzyl ammonium chloride, cocodiamine, and mixtures thereof.

Examples of phosphonium salts include, for example, tributyltetradecyl phosphonium chloride.

Other examples of commonly available non-oxidizing biocides may include dibromonitfilopropionamide, thiocyanomethylthiobenzothlazole, methyldithiocarbamate, tetrahydrodimethylthladiazonethione, tributyltin oxide, bromonitropropanediol, bromonitrostyrene, methylene bisthiocyanate, chloromethylisothlazolone, methylisothiazolone, benzisothlazolone, dodecylguanidine hydrochloride, polyhexamethylene biguanide, tetrakis(hydroxymethyl)phosphonium sulfate, glutaraldehyde, alkyldimethylbenzyl ammonium chloride, didecyldimethylammonium chloride, poly [oxyethylene-(dimethyliminio)ethylene(dimethyliminio)ethylene dichloride], decylthioethanamine, and terbuthylazine.

Other examples of non-oxidizing biocides may include isothiazolinone biocides such as, for example, 5-chloro-2-methyl-4-isothiazolin-3-one, 2-methyl-4-isothiazolin-3-one, and 1,2-benzisothiazolin-3-one and combinations thereof.

Additional examples of non-oxidizing biocides may include, for example, 2-bromo-2-nitro-1,3-propanediol, 2-2-dibromo-3-nitrilopropionamide, tris(hydroxymethyl)nitromethane, 5-bromo-5-nitro-1,3-dioxane and sulfur compounds, such as, for example, isothiazolone, carbamates, to and metronidazole.

Additional examples of oxidizing and non-oxidizing biocides include triazines such as 1,3,5-tris-(2-hydroxyethyl)-s-triazine and trimethyl-1,3,5-triazine-1,3,5-triethanol.

### EXAMPLES

### Example 1: Compatibility Study of Capsules with Commercial Corrosion Inhibitor Packages

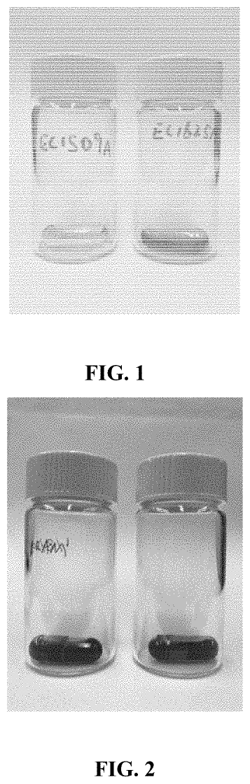

Two commercial corrosion inhibitor packages (EC1509A (Nalco) and EC1625A (Nalco)) were separately encapsulated in gelatin capsules, as shown in the photograph of FIG. 1. The gelatin capsules were made from beef gelatin and purified water. As well as the quaternary ammonium components and imidazoline-based surfactants in EC1509A and EC1625A respectively and which constitute the active corrosion inhibition components, both packages contained methanol, isopropanol or isobutanol as solvent and some organic sulphur compounds. After 30 days, both corrosion inhibitor packages in a liquid form remained enclosed in the capsules, indicating compatibility of the gelatin capsules with corrosion inhibitor packages.

### Example 2: Compatibility Study of Capsules with Crude Oils

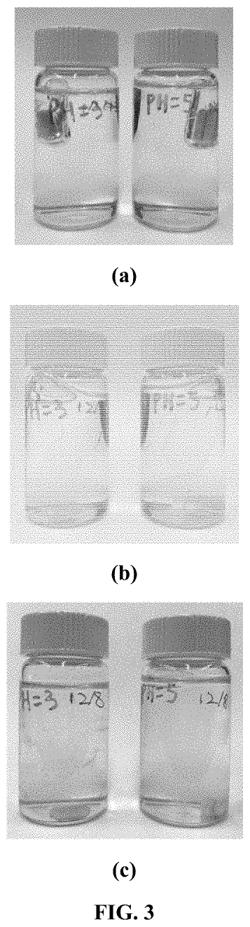

Two crude oils, Mobil Producing Nigeria (MPN) in left vial and Mobil Equatorial Guinea Inc. (MEGI) in right vial, were encapsulated in separate gelatin capsules, as shown in the photograph of FIG. 2. After 30 days, the capsules were intact and the crude oils remained enclosed in the capsules. This indicates that the gelatin capsules were compatible with the crude oils.

### Example 3: Dissolution Study of Capsules in Acidic Brines

Gelatin capsules having a small magnetic stir bar enclosed as a weight were added to

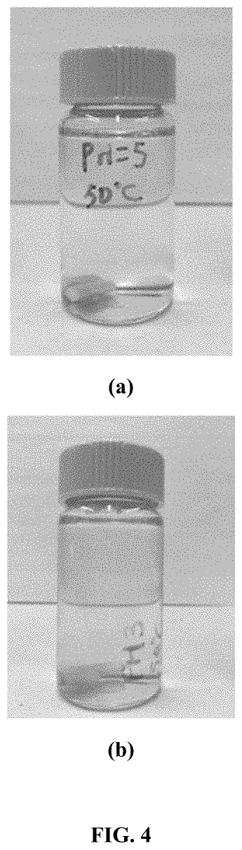

1 wt. % NaCl solutions at room temperature having pH=3 and pH=5 respectively. The vial on the left of the photograph of FIG. 3(a) is pH=3 and the vial of the right pH=5. Four hours after addition both capsules had swelled and opened so that the magnetic stir bars sank to the bottom of the vials. This is shown in the photograph of FIG. 3(b).

After 25 days, the capsule in pH=3 brine was mostly dissolved and only very small residual flakes were observed (see the left vial in the photograph of FIG. 3(c)). The capsule in the pH=5 brine at room temperature after 25 days was further swelled, as the size of the opened half capsules was increased (see the right vial in the photograph of FIG. 3(c)). This suggests that the gelatin capsules can dissolve in acidic brine at room temperature with the time of dissolution dependent on pH. The lower the pH, the faster the capsule dissolved.

The rate of dissolution of the gelatin capsules in acidic brine also increased with increasing temperature. The photographs in FIG. 4 indicate that most of the gelatin capsule was dissolved in pH=5, 1 wt. % NaCl solution at 50° C. within the 10 minutes (photograph of FIG. 4(a)). The dissolution rate was further increased in the pH=3, 1 wt. % NaCl solution at 50° C. as the gelatin capsule was fully dissolved within a few minutes of addition to the vial (photograph of FIG. 4(b)).

### Example 4: Compatibility Study of Capsules with Ethylene Glycol and Sodium Chloride

To increase the density of the capsule assembly for direct delivery of the encapsulated

chemicals to the targeted area, for example, a water/steel interface, a liquid or liquids, for example, ethylene glycol or glycerol and/or water-soluble solids with a density higher than water may be utilized. In some cases, the water soluble solid may be encapsulated in a smaller capsule with the main capsule.

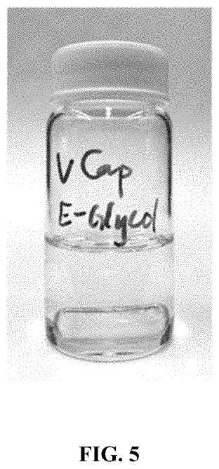

Sodium chloride solid particles were encapsulated in a vegetable capsule and the capsule added to ethylene glycol in a glass vial, as shown in the photograph in FIG. 5. The vegetable capsule was commercially available and was made from hydroxypropylmethylcellulose and purified water. After 3 days, the capsule was intact and the sodium chloride particles were retained in the capsule. This indicates that the vegetable capsule is compatible with sodium chloride and ethylene glycol.

### Example 5: Corrosion Inhibition Performance of Encapsulated Commercial Inhibitor Package Vs. Directly Injected Inhibitor Package

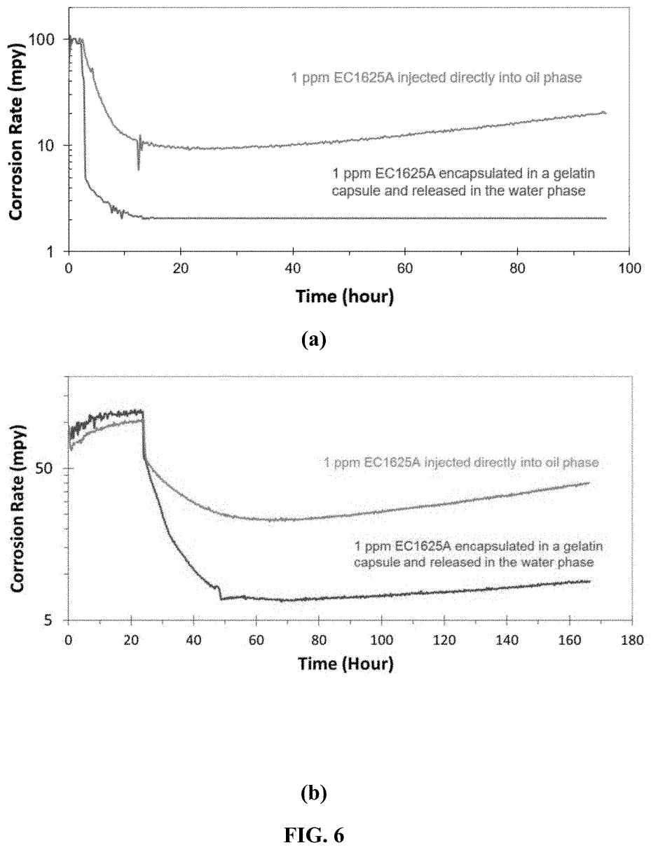

The inhibition performance of encapsulated corrosion inhibitor as compared to directly injected corrosion inhibitor in an oil and water environment was tested and the results are illustrated in FIG. 6. Corrosion tests were conducted in corrosion kettles filled with 70 vol. % 1 wt. % NaCl solution and 30 vol. % MPN crude at 40° C. The kettles were continuously purged with 1 bar CO₂, stirred with a magnetic bar rotating at a speed of 200 rpm, and the pH of the brine phase was adjusted to pH=5 using sodium bicarbonate.

Electrochemical corrosion tests were undertaken using a standard three electrode arrangement, using a platinum wire as counter electrode, a saturated calomel electrode as reference electrode, and a cylindrical working electrode made from X65 carbon steel. For the encapsulated corrosion inhibitor sample, 1 ppm EC1625A (concentration in total fluid by volume) was encapsulated in a gelatin capsule together with sodium chloride (0.6 gram) for density control. Once the capsule with corrosion inhibitor was added to the kettle, the capsule sank to the bottom of the kettle and released the corrosion inhibitor into the brine phase within one minute. The capsule together with the encapsulated salt dissolved completely in the brine within 5 minutes of addition.

As shown in FIG. 6(a), a lower corrosion rate was observed when 1 ppm EC1625A was encapsulated in the gelatin capsule and released directly into the lower brine phase, compared to the case where 1 ppm EC1625A was injected into the upper oil phase in the kettle after two-hour pre-corrosion. Furthermore, the corrosion rate stabilized for the encapsulated inhibitor and remained stable over a long time period. In contrast the corrosion rate of the inhibitor injected directly into the oil phase continued to rise. FIG. 6(b) illustrates the results of comparative experiments in which the inhibitor was added after a twenty four-hour pre-corrosion period. Again, significantly reduced corrosion rates were observed for the encapsulated inhibitor. This demonstrates that targeted delivery of corrosion inhibitor into the brine phase using water-soluble capsules can enhance the performance of the corrosion inhibitor. This may be due to reduced corrosion inhibitor loss into oil phase during injection.

All patents, patent applications and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in the art in light of the above detailed description. All such obvious variations are within the full intended scope of the appended claims.

1. A chemical component delivery system, said system comprising a plurality of delivery capsules, said delivery capsules comprising one or more chemical components encapsulated within shells, said shells being degradable and/or soluble in an aqueous environment.

2. A method of delivering chemical components to a water phase or water/vessel wall interface of a multiphase environment comprising the steps of:
introducing one or more delivery capsules to a multiphase environment, said capsules comprising one or more chemical components encapsulated within shells, said shells being degradable and/or soluble in an aqueous environment;
allowing the capsules to migrate to the water phase or water/vessel wall interface; and
allowing the components to be released from the delivery capsules.

3. A system according to claim 1 or a method according to claim 2, wherein the chemical components comprise one or more corrosion inhibitors, one or more biocides, or mixtures thereof.

4. A system according to claim 1 or a method according to claim 2, wherein at least a first fraction of capsules comprise one or more of a first set of chemical components encapsulated therein, and at least a second fraction of capsules comprise one or more of a second set of chemical components encapsulated therein, wherein the second set of chemical components comprise at least some chemicals which are different to those of the first set.

5. A system according to claim 1 or a method according to claim 2, comprising at least a first fraction of capsules comprising one or more corrosion inhibitors encapsulated therein and at least a second fraction of capsules comprising one or more corrosion inhibitors encapsulated therein, wherein at least some of the corrosion inhibitors encapsulated in the first and second fractions are different.

6. A system according to claim 1 or a method according to claim 2, comprising at least a first fraction of capsules comprising one or more biocides encapsulated therein and at least a second fraction of capsules comprising one or more biocides encapsulated therein, wherein at least some of the biocides encapsulated in the first and second fractions are different.

7. A system according to claim 1 or a method according to claim 2, comprising at least a first fraction of capsules comprising one or more corrosion inhibitors encapsulated therein and at least a second fraction of capsules comprising one or more biocides encapsulated therein.

8. A system according to claim 1 or a method according to claim 2, comprising at least three fractions of capsules, each fraction comprising at least one chemical component encapsulated therein that is different from the other fractions.

9. A system according to claim 1 or a method according to claim 2, wherein individual capsules comprise two or more separate compartments each comprising different chemical components.

10. A system according to claim 1 or a method according to claim 2, wherein individual capsules comprise one or more further capsules encapsulated therein.

11. A system according to claim 1 or a method according to claim 2, wherein the shells comprise materials that degrade or dissolve in aqueous acid, brine or acidic brine.

12. A system according to claim 1 or a method according to claim 2, wherein the material of the shells is resistant to degradation or dissolution in an oil environment.

13. A system according to claim 1 or a method according to claim 2, wherein the shells comprise dextran, cellulose, chitin, chitosan, protein, aliphatic polyester, poly(lactide), poly(glycolide), poly(ε-caprolactone), poly(hydroxy butyrate), poly(anhydride), aliphatic poly(carbonate), poly(orthoester), poly(amino acid), poly (ethylene oxide), poly(phosphazene) or polyurethanes comprising ester linkages.

14. A system according to claim 1 or a method according to claim 2, wherein the shells comprise gelatin or hydroxypropyl methyl cellulose.

15. A system according to claim 1 or a method according to claim 2, wherein the density of the capsules is greater than the density of water or greater than the density of brine.

16. A system according to claim 1 or a method according to claim 2, wherein the density of the capsules is greater than 1.00 g/cm³.

17. A system according to claim 1 or a method according to claim 2, wherein the capsules comprise a liquid having a higher density than water or brine.

18. A system according to claim 1 or a method according to claim 2, wherein the capsules comprise a liquid which is miscible with water.

19. A system according to claim 1 or a method according to claim 2, wherein the capsules comprise a solid which has a higher density than water or brine.

20. A system according to claim 1 or a method according to claim 2, wherein the capsules comprise a solid which is miscible with water.

21. A system according to claim 1 or a method according to claim 2, wherein the capsules are about 10 nm to about 20 mm in size.

22. A system according to claim 1 or a method according to claim 2, wherein the capsules have a wall thickness of about 1 nm to about 2 mm.

23. A system according to claim 1 or a method according to claim 2, wherein the shells of the capsules comprise a degradable material that degrades so as to substantially dissolve in water over time.

24. A system according to claim 1 or a method according to claim 2, wherein the rate of degradation of the shells of the capsules increases with decreasing pH.

25. A system according to claim 1 or a method according to claim 2, wherein the capsule shells rupture so as to release at least some of the encapsulated chemical components within 30 minutes or less when exposed to water.

26. A system according to claim 1 or a method according to claim 2, wherein the capsule shells substantially dissolve in water, or in acidic water, or brine, or acidic brine.

27. A system or method according to claim 5, wherein the corrosion inhibitor comprises one or more surfactants selected from a non-ionic surfactant, an ionic surfactant, an amphoteric surfactant, or mixtures thereof.

28. A method according to claim 2, wherein the multiphase environment is an oil and water environment.

29. A method according to claim 28, wherein the water is production water from an oil well.

30. A method according to claim 28, wherein the oil is crude oil from an oil well.

31. A method according to claim 28, wherein the water has a pH less than 7.0.
